(19) United States
(12) Patent Application Publication
(10) Pub. No.: US 2014/0227606 A1
(43) Pub. Date: Aug. 14, 2014

(54) ALL SOLID STATE BATTERY AND METHOD FOR PRODUCING SAME

(71) Applicants: Tomoya Suzuki, Kariya-shi (JP); Takayuki Uchiyama, Susono-shi (JP)

(72) Inventors: Tomoya Suzuki, Kariya-shi (JP); Takayuki Uchiyama, Susono-shi (JP)

(73) Assignee: TOYOTA JIDOSHA KABUSHIKI KAISHA, Toyota-shi, Aichi (JP)

(21) Appl. No.: 14/343,601

(22) PCT Filed: Sep. 30, 2011
(86) PCT No.: PCT/JP2011/072594

§ 371 Date: Mar. 7, 2014

(51) Int. Cl. H01M 10/0562; H01M 10/058

(52) U.S. Cl. CPC H01M 10/0562; H01M 10/058; H01M 2300/0068
USPC 429/304; 427/58

(57) ABSTRACT

An all solid state battery can inhibit interface resistance between a cathode active material and a solid electrolyte material from increasing with time. The battery includes a cathode active material layer, an anode active material layer, and a solid electrolyte layer formed therebetween. The cathode active material layer and/or the solid electrolyte layer contains a sulfide solid electrolyte material, a reaction inhibition portion having two layers of a lithium ion layer having a first lithium ion conductor on an active material side and a stabilization layer having a second lithium ion conductor on a solid electrolyte side is formed on the cathode active material layer. The first lithium ion conductor is a compound with a lithium ion conductivity of 1×10⁻⁷ S/cm or more at normal temperature, and the second lithium ion conductor is a compound with a polyanion structure having B, Si, P, Ti, Zr, Al and/or W.

### TECHNICAL FIELD

The present invention relates to an all solid state battery capable of inhibiting interface resistance between a cathode active material and a sulfide solid electrolyte material from increasing with time.

### BACKGROUND ART

In accordance with a rapid spread of information relevant apparatuses and communication apparatuses such as a personal computer, a video camera and a portable telephone in recent years, the development of a battery to be utilized as a power source thereof has been emphasized. Also, in the automobile industry, the development of a high-output and high-capacity battery has been advanced for an electric automobile and a hybrid automobile, and the development of a lithium battery with high energy density has been advanced.

Liquid electrolyte containing a flammable organic solvent is used for a conventionally commercialized lithium battery, so that the installation of a safety device for inhibiting temperature rise during a short circuit and the improvement in structure and material for preventing the short circuit are necessary therefor. On the contrary, a lithium battery all-solidified by replacing the liquid electrolyte with a solid electrolyte layer is conceived to intend the simplification of the safety device and be excellent in production cost and productivity for the reason that the flammable organic solvent is not used in the battery.

The intention of improving performance of an all solid state battery while focusing on the interface between a cathode active material and a solid electrolyte material has been conventionally attempted in the field of such an all solid state battery. For example, in Non Patent Literature 1, a material such that the surface of LiCoO₂ as a cathode active material is covered with LiNbO₃ is disclosed. This technique intends to achieve higher output of a battery by covering the surface of LiCoO₂ with LiNbO₃ to decrease interface resistance between LiCoO₂ and a solid electrolyte material.

Also, in Patent Literature 1, a material for a cathode active material such that a cathode active material is covered with a resistive layer formation inhibition coat having lithium ion conductivity is disclosed; in Patent Literature 2, a material for a cathode active material such that a cathode active material is covered with LiNbO₃ to regulate a covering state with measurement by XPS is disclosed. This intends to inhibit interface resistance between an oxide cathode active material and a solid electrolyte material from increasing at high temperature by uniformizing the thickness of LiNbO₃ for covering.

### CITATION LIST

### Patent Literature

Patent Literature 1: Japanese Patent Application Publication (JP-A) No. 2009-266728
Patent Literature 2: JP-A No. 2010-170715

### Non Patent Literature

Non Patent Literature 1: Narumi Ohta et al., “LiNbO₃-coated LiCoO₂ as cathode material for all solid-state lithium secondary batteries”, Electrochemistry Communications 9 (2007), 1486-1490

### SUMMARY OF INVENTION

### Technical Problem

As described in the above-mentioned Patent Literatures 1 and 2, the formation of a reaction inhibition portion containing a material excellent in ion conductivity on the surface of the cathode active material allows interface resistance between the cathode active material and the solid electrolyte material to be decreased in producing an all solid state battery. However, interface resistance increases with time, so that a problem is brought to durability.

The present invention has been made in view of the above-mentioned actual circumstances, and a main object thereof is to provide an all solid state battery capable of decreasing interface resistance between a cathode active material and a sulfide solid electrolyte material to inhibit the interface resistance from increasing with time.

### Solution to Problem

In order to achieve the above-mentioned object, the present invention provides an all solid state battery comprising a cathode active material layer containing a cathode active material, an anode active material layer containing an anode active material, and a solid electrolyte layer formed between the above-mentioned cathode active material layer and the above-mentioned anode active material layer, wherein at least one of the above-mentioned cathode active material layer and the above-mentioned solid electrolyte layer contains a sulfide solid electrolyte material, a reaction inhibition portion having two layers of a lithium ion conductive layer having a first lithium ion conductor on an active material side and a stabilization layer having a second lithium ion conductor on a solid electrolyte side is formed on a surface of the above-mentioned cathode active material, the above-mentioned first lithium ion conductor is an Li-containing compound with a lithium ion conductivity of 1.0×10⁻⁷ S/cm or more at normal temperature, and the above-mentioned second lithium ion conductor is an Li-containing compound provided with a polyanion structural portion having at least one of B, Si, P, Ti, Zr, Al and W.

According to the present invention, in forming the reaction inhibition portion on the surface of the cathode active material, the lithium ion conductive layer containing the first lithium ion conductor with favorable Li ion conductivity is covered so as to be on the active material side, and the stabilization layer containing the second lithium ion conductor including metal with high electronegativity is covered so as to be on the solid electrolyte layer side; therefore, an oxygen atom becomes difficult to be pulled out of the reaction inhibition portion in contact with the solid electrolyte layer and thereby the reaction inhibition portion may be inhibited from deteriorating and interface resistance may be inhibited from increasing with time.

In the above-mentioned invention, the above-mentioned first lithium ion conductor is preferably LiNbO₃.

In the above-mentioned invention, the above-mentioned second lithium ion conductor is preferably Li₂Ti₂O₅. Ti forms an oxide film on the surface thereof to easily be in a passive state, and the Li-containing compound provided with the polyanion structural portion having Ti exhibits so high corrosion resistance as to increase electrochemical stability. Thus, an oxygen atom in the reaction inhibition portion becomes difficult to be pulled out in contact with the electrolyte and thereby the all solid state battery may be inhibited from deteriorating.

Also, the present invention provides a method for producing the above-mentioned all solid state battery, comprising steps of: a lithium ion conductive layer forming step of forming a lithium ion conductive layer by applying and heat-treating a first precursor coating liquid containing a raw material for the above-mentioned first lithium ion conductor on a surface of a cathode active material, and a stabilization layer forming step of forming a stabilization layer by applying and heat-treating a second precursor coating liquid containing a raw material for the above-mentioned second lithium ion conductor on a surface of the lithium ion conductive layer covered with the cathode active material.

According to the present invention, after the lithium ion conductive layer is covered by applying and heat-treating the above-mentioned first precursor coating liquid on the surface of the cathode active material, the stabilization layer is covered by further applying and heat-treating the above-mentioned second precursor coating liquid, so that interface resistance between the cathode active material and the sulfide solid electrolyte material may be inhibited from increasing with time, and the all solid state battery excellent in Li ion conductivity and durability may be produced simply and easily.

In the above-mentioned invention, the above-mentioned first lithium ion conductor is preferably LiNbO₃.

In the above-mentioned invention, the above-mentioned second lithium ion conductor is preferably Li₂Ti₂O₅.

### Advantageous Effects of Invention

The present invention produces the effect such as to allow interface resistance between a cathode active material and a sulfide solid electrolyte material to be inhibited from increasing with time.

### BRIEF DESCRIPTION OF DRAWINGS

FIGS. 1A and 1B are explanatory views showing an example of a power generating element of an all solid state battery of the present invention.

FIG. 2 is a schematic cross-sectional view showing an example of a reaction inhibition portion in the present invention.

FIG. 3 is a flow chart showing an example of a method for producing an all solid state battery of the present invention.

FIG. 4 is a graph showing initial interface resistance of an all solid state battery obtained in each of Example and Comparative Examples 1 and 2.

FIG. 5 is a graph showing a change in interface resistance under a 60° C.-storage environment of an all solid state battery obtained in each of Example and Comparative Examples 1 and 2.

FIG. 6 is a TEM image of a cross section of a cathode active material of an all solid state battery obtained in each of Example and Comparative Example 3.

FIG. 7 is a graph showing a change in interface resistance under a 60° C.-storage environment of an all solid state battery obtained in each of Example and Comparative Example 3.

### DESCRIPTION OF EMBODIMENTS

An all solid state battery and a method for producing the all solid state battery of the present invention are hereinafter described in detail.

A. All Solid State Battery

The all solid state battery of the present invention is an all solid state battery comprising a cathode active material layer containing a cathode active material, an anode active material layer containing an anode active material, and a solid electrolyte layer formed between the above-mentioned cathode active material layer and the above-mentioned anode active material layer, wherein at least one of the above-mentioned cathode active material layer and the above-mentioned solid electrolyte layer contains a sulfide solid electrolyte material, a reaction inhibition portion having two layers of a lithium ion conductive layer having a first lithium ion conductor on an active material side and a stabilization layer having a second lithium ion conductor on a solid electrolyte layer side is formed on a surface of the above-mentioned cathode active material, the above-mentioned first lithium ion conductor is an Li-containing compound with a lithium ion conductivity of 1.0×10⁻⁷ S/cm or more at normal temperature, and the above-mentioned second lithium ion conductor is an Li-containing compound provided with a polyanion structural portion having at least one of B, Si, P, Ti, Zr, Al and W.

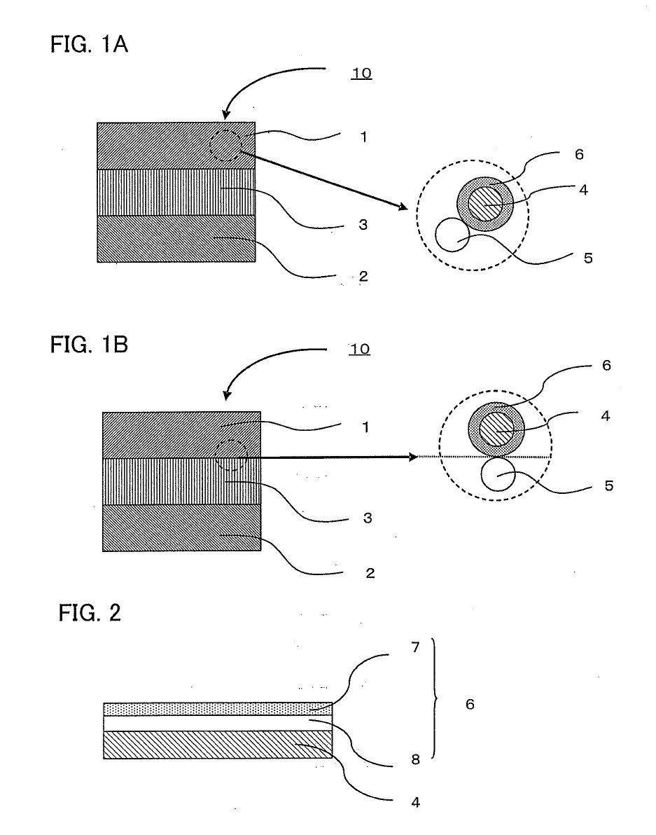

FIGS. 1A and 1B are explanatory views showing an example of a power generating element of the all solid state battery of the present invention. A power generating element 10 of the all solid state battery exemplified in FIGS. 1A and 1B has a cathode active material layer 1, an anode active material layer 2, and a solid electrolyte layer 3 formed between the cathode active material layer 1 and the anode active material layer 2. Also, the cathode active material layer 1 has a cathode active material 4 on whose surface a reaction inhibition portion 6 is formed. In addition, a sulfide solid electrolyte material 5 is contained in at least one of the cathode active material layer 1 and the solid electrolyte layer 3, and contacts the cathode active material 4 through the reaction inhibition portion 6. Thus, the sulfide solid electrolyte material 5 may be contained in the cathode active material layer 1 as shown in FIG. 1A, contained in the solid electrolyte layer 3 as shown in FIG. 1B, or contained in both the cathode active material layer 1 and the solid electrolyte layer 3 (not shown).

According to the present invention, after a lithium ion conductive layer containing a first lithium ion conductor with favorable Li ion conductivity covers a surface of the cathode active material, a stabilization layer containing a second lithium ion conductor with high electrochemical stability covers a surface of the above-mentioned lithium ion conductive layer, whereby the reaction inhibition portion having the two layers is formed, so that as compared with a conventional reaction inhibition portion formed from only a niobium oxide (such as LiNbO₃), the structure of the first lithium ion conductor may be inhibited from changing in contact with the sulfide solid electrolyte material to allow the reaction inhibition portion with high electrochemical stability. Thus, interface resistance against the sulfide solid electrolyte material may be inhibited from increasing with time to consequently allow durability of the all solid state battery to be improved. Incidentally, the above-mentioned second lithium ion conductor is provided with a polyanion structural portion having at least one of B, Si, P, Ti, Zr, Al and W, and is high in electrochemical stability as described later.

The all solid state battery of the present invention is hereinafter described in each constitution.

1. Cathode Active Material Layer

First, the cathode active material layer in the present invention is described. The cathode active material layer used for the present invention is a layer containing at least the cathode active material. Also, the cathode active material layer in the present invention may contain at least one of a solid electrolyte material and a conductive material as required. In the present invention, the cathode active material layer contains a sulfide solid electrolyte material particularly preferably. The reason therefor is to allow ion conductivity of the cathode active material layer to be improved.

(1) Cathode Active Material

The cathode active material used for the present invention is described. The cathode active material in the present invention is not particularly limited if the charge and discharge electric potential thereof is a noble electric potential as compared with the charge and discharge electric potential of the anode active material contained in the after-mentioned anode active material layer. Preferable examples of such a cathode active material include an oxide cathode active material from the viewpoint of reacting with the after-mentioned sulfide solid electrolyte material to form a high resistive layer. Also, the use of the oxide cathode active material allows the all solid state battery with high energy density.

Examples of the oxide cathode active material used for the present invention can include a cathode active material represented by a general formula LiₓM_{y}O_{z} (M is a transition metallic element, x=0.02 to 2.2, y=1 to 2 and z=1.4 to 4). In the above-mentioned general formula, M is preferably at least one kind selected from the group consisting of Co, Mn, Ni, V, Fe and Si, and more preferably at least one kind selected from the group consisting of Co, Ni and Mn. Also, an oxide cathode active material represented by a general formula Li₁₊ₓMn_{2-x-y}M_{y}O₄ (M is at least one kind selected from Al, Mg, Co, Fe, Ni and Zn, 0≦xφ1, 0φyφ2, and 0φx+yφ2) may be used as the oxide cathode active material. Specific examples of Such an oxide cathode active material can include LiCoO₂, LiMnO₂, LiNiO₂, LiVO₂, LiNi_{1/3}Co_{1/3}Mn_{1/3}O₂, LiMn₂O₄, Li(Ni_{0.5}Mn_{1.5})O₄, Li₂FeSiO₄ and Li₂MnSiO₄.

Examples of the shape of the cathode active material include a particulate shape such as a perfectly spherical shape and an elliptically spherical shape, and a thin-film shape, preferably a particulate shape, above all. Also, in the case where the cathode active material is in a particulate shape, the average particle diameter thereof is, for example, preferably within a range of 0.1 μm to 50 μm. The content of the cathode active material in the cathode active material layer is, for example, preferably within a range of 10% by weight to 99% by weight, and more preferably within a range of 20% by weight to 90% by weight.

(2) Reaction Inhibition Portion

The reaction inhibition portion in the present invention is described. The reaction inhibition portion used for the present invention is formed on the surface of the above-mentioned cathode active material, and has two layers of a lithium ion conductive layer having a first lithium ion conductor on the active material side and a stabilization layer having a second lithium ion conductor on the solid electrolyte layer side. FIG. 2 is a schematic cross-sectional view showing an example of the reaction inhibition portion in the present invention. As exemplified in FIG. 2, the reaction inhibition portion 6 having a lithium ion conductive layer 8 and a stabilization layer 7 is formed on the surface of the cathode active material 4. The lithium ion conductive layer 8 covers the surface of the cathode active material 4, and the stabilization layer 7 covers the surface of the above-mentioned lithium ion conductive layer 8. Among the above-mentioned two layers composing the reaction inhibition portion, the first lithium ion conductor contained in the above-mentioned lithium ion conductive layer is an Li-containing compound with a lithium ion conductivity of 1.0×10⁻⁷ S/cm or more at normal temperature, and the second lithium ion conductor contained in the above-mentioned stabilization layer is an Li-containing compound provided with a polyanion structural portion having at least one of B, Si, P, Ti, Zr, Al and W. The reaction inhibition portion has the function of inhibiting a reaction between the cathode active material and the sulfide solid electrolyte material, which is produced during the use of the all solid state battery. In the present invention, the reaction inhibition portion has a structure in which the surface of the lithium ion conductive layer is covered with the stabilization layer, as described above. Thus, deterioration due to the contact between the first lithium ion conductor and the sulfide solid electrolyte material may be inhibited, and durability may be improved as compared with a conventional reaction inhibition portion formed from only a niobium oxide (such as LiNbO₃).

Each constitution of the reaction inhibition portion is hereinafter described.

(i) Lithium Ion Conductive Layer

The lithium ion conductive layer in the present invention comprises a material having the first lithium ion conductor with favorable conductivity as described later, and is formed on the surface of the above-mentioned cathode active material, and thereby is characterized in that interface resistance caused between the cathode active material and the sulfide solid electrolyte material is decreased and output is inhibited from decreasing.

Also, the form of the lithium ion conductive layer in the present invention is not particularly limited if the lithium ion conductive layer is such as to be formed on the surface of the above-mentioned cathode active material. For example, as shown in FIGS. 1A and 1B, in the case where the shape of the above-mentioned cathode active material is particulate, the form of the lithium ion conductive layer is preferably a form such as to cover the surface of the cathode active material. Also, the lithium ion conductive layer preferably covers more areas of the above-mentioned cathode active material particles (occasionally referred to simply as particles hereinafter), and the specific coverage factor on the above-mentioned particle surface is preferably 80% or more, and more preferably 95% or more. Also, the whole particle surface may be covered. Incidentally, examples of a measuring method for the coverage factor of the lithium ion conductive layer can include transmission electron microscope (TEM) and X-ray photoelectron spectroscopy (XPS).

The thickness of the lithium ion conductive layer in the present invention is not particularly limited if the thickness is such that the cathode active material and the sulfide solid electrolyte material do not react, but is, for example, preferably within a range of 1 nm to 100 nm, and more preferably within a range of 1 nm to 20 nm. The reason therefor is that the case where the thickness of the lithium ion conductive layer is less than the above-mentioned range brings a possibility that the cathode active material and the sulfide solid electrolyte material react. On the other hand, the reason therefor is that the case where the thickness of the lithium ion conductive layer exceeds the above-mentioned range brings a possibility of decreasing Li ion conductivity. Incidentally, examples of a measuring method for the thickness of the lithium ion conductive layer can include an image analysis by using transmission electron microscope (TEM).

Also, with regard to the conductivity of the lithium ion conductive layer in the present invention, the first lithium ion conductor contained therein is preferably in a range of the lithium ion conductivity at normal temperature described in the item of the after-mentioned “(a) First lithium ion conductor”. The conductivity of the lithium ion conductive layer in the after-mentioned range allows the lithium ion conductivity to be inhibited from decreasing in covering the surface of the cathode active material, and allows output in the all solid state battery to be inhibited from decreasing.

A forming method for the lithium ion conductive layer in the present invention is not particularly limited if the method is such as to allow the covering as described above to be formed. Examples of the forming method for the lithium ion conductive layer can include a method for making the cathode active material into a tumbling flow state to apply and heat-treat a coating liquid containing a forming material for the lithium ion conductive layer, in the case where the shape of the cathode active material is particulate. Also, in the case where the shape of the cathode active material is a thin film, examples thereof can include a method for applying and heat-treating a coating liquid containing a forming material for the lithium ion conductive layer on the cathode active material. The wording “heat-treat” in this case signifies that the cathode active material applied with the coating liquid is dried and burned. In particular, in the present invention, the method described in the item of the after-mentioned “B. Method for producing all solid state battery” may be appropriately used.

Each component of the lithium ion conductive layer is hereinafter described.

(a) First Lithium Ion Conductor

The first lithium ion conductor in the present invention is ordinarily an Li-containing compound with a lithium ion conductivity of 1.0×10⁻⁷ S/cm or more at normal temperature. With regard to the first lithium ion conductor, the lithium ion conductivity at normal temperature is more preferably 1.0×10⁻⁶ S/cm or more, above all. The first lithium ion conductor exhibits a lithium ion conductivity in the above-mentioned range, so that Li ion conductivity may be inhibited from decreasing in forming the reaction inhibition portion on the surface of the cathode active material. Thus, output characteristics may be inhibited from decreasing in the all solid state battery using the cathode active material layer containing the cathode active material on whose surface the reaction inhibition portion is formed. Incidentally, a measuring method for lithium ion conductivity is not particularly limited if the method is such that the lithium ion conductivity at normal temperature of the first lithium ion conductor in the present invention may be measured, but examples thereof can include a measuring method by using an alternating current impedance method.

The first lithium ion conductor is not particularly limited if the first lithium ion conductor is such as to have a lithium ion conductivity in the above-mentioned range, but examples thereof can include an Li-containing oxide such as LiNbO₃ and LiTaO₃, and a NASICON type phosphoric acid compound. Above all, the Li-containing oxide is preferable and LiNbO₃ is particularly preferable. The reason therefor is to allow the effect of the present invention to be further produced. Incidentally, examples of the above-mentioned NASICON type phosphoric acid compound can include Li₁₊ₓAlₓTi₂₋ₓ(PO₄)₃ (0φxφ2) (LATP) and Li₁₊ₓAlₓGe₂₋ₓ(PO₄)₃ (0φxφ2) (LAGP). In LATP, in the above-mentioned general formula, a range of “x” may be 0 or more, preferably more than 0 above all, and particularly preferably 0.3 or more. On the other hand, the range of “x” may be 2 or less, and preferably 1.7 or less above all, particularly preferably 1 or less. In particular, in the present invention, Li_{1.5}Al_{0.5}Ti_{1.5}(PO₄)₃ is preferable. Also, in LAGP, in the above-mentioned general formula, a range of “x” may be 0 or more, preferably more than 0 above all, and particularly preferably 0.3 or more. On the other hand, the range of “x” may be 2 or less, and preferably 1.7 or less above all, particularly preferably 1 or less. In particular, in the present invention, Li_{1.5}Al_{0.5}Ge_{1.5}(PO₄)₃ may be appropriately used.

(b) Other Components

The lithium ion conductive layer in the present invention may contain, in addition to the above-mentioned first lithium ion conductor, a conductive material and a binder which do not have reactivity with the above-mentioned cathode active material and solid electrolyte material. Examples of the conductive material can include acetylene black, Ketjen Black and carbon fiber. Examples of the binder can include fluorine-containing binders such as PTFE and PVDF.

(ii) Stabilization Layer

The stabilization layer in the present invention comprises a material having the second lithium ion conductor with high electronegativity as described later, and particularly preferably comprises an Li-containing compound provided with a polyanion structural portion. The stabilization layer is formed on the surface of the above-mentioned lithium ion conductive layer, and thereby is characterized in that electrochemical stability of the cathode active material layer is improved and deterioration is inhibited. According to the present invention, after the above-mentioned lithium ion conductive layer covers the surface of the cathode active material, the stabilization layer covers, so that the lithium ion conductive layer may be prevented from directly contacting the sulfide solid electrolyte layer, and the cathode active material layer may be inhibited from deteriorating due to the contact with the sulfide solid electrolyte material.

The form of the stabilization layer in the present invention is not particularly limited if the stabilization layer is such as to be formed on the surface of the above-mentioned lithium ion conductive layer. For example, as shown in FIGS. 1A and 1B, in the case where the shape of the above-mentioned cathode active material is particulate, the form of the stabilization layer is preferably a form such as to cover the surface of the cathode active material particles (occasionally referred to simply as covered particles hereinafter) which are covered with the lithium ion conductive layer. The specific coverage factor on the above-mentioned covered particle surface is preferably 80% or more, and more preferably 95% or more. Also, the whole covered particle surface may be covered. Incidentally, examples of a measuring method for the coverage factor of the stabilization layer can include transmission electron microscope (TEM) and X-ray photoelectron spectroscopy (XPS).

The thickness of the stabilization layer in the present invention is not particularly limited if the thickness is such that the cathode active material and the sulfide solid electrolyte material do not react. The thickness is, for example, preferably within a range of 1 nm to 100 nm, and more preferably within a range of 1 nm to 20 nm. The reason therefor is that the case where the thickness of the stabilization layer is less than the above-mentioned range brings a possibility that the effect of electrochemical stability of the second lithium ion conductor decrease and durability of the reaction inhibition portion be inhibited from improving. On the other hand, the reason therefor is that the case where the thickness of the stabilization layer exceeds the above-mentioned range brings a possibility of increasing initial interface resistance between the cathode active material layer and the sulfide solid electrolyte material. Incidentally, examples of a measuring method for the thickness of the stabilization layer can include an image analysis by using transmission electron microscope (TEM).

A forming method for the stabilization layer in the present invention is not particularly limited if the method is such as to allow the covering as described above to be formed. Examples of the forming method for the stabilization layer can include a method for making the cathode active material into a tumbling flow state to apply and heat-treat a coating liquid containing a forming material for the stabilization layer, in the case where the shape of the cathode active material is particulate. Also, in the case where the shape of the cathode active material is a thin film, examples thereof can include a method for applying and above-mentioned heat-treating a coating liquid containing a forming material for the stabilization layer on the cathode active material. In particular, in the present invention, the method described in the item of the after-mentioned “B. Method for producing all solid state battery” may be appropriately used.

Each component of the stabilization layer is hereinafter described.

(a) Second Lithium Ion Conductor

The second lithium ion conductor in the present invention is ordinarily an Li-containing compound provided with a polyanion structural portion having at least one of B, Si, P, Ti, Zr, Al and W. The second lithium ion conductor is so high in electrochemical stability that structural change caused in contact with the sulfide solid electrolyte material may be inhibited. The reason why the second lithium ion conductor is high in electrochemical stability is as follows.

That is to say, in the case where the second lithium ion conductor is an Li-containing compound provided with a polyanion structural portion having at least one of B, Si, P, Al and W, electronegativity of each element of B, Si, P, Al and W becomes larger as compared with electronegativity (1.60) of Nb contained in a compound used for a conventional reaction inhibition portion, such as a niobium oxide, in electronegativity of Pauling; therefore, a difference from electronegativity (3.44) of an oxygen element becomes so smaller as compared with Nb that a more stable covalent bond may be formed. As a result, electrochemical stability becomes higher. Also, in the case where the second lithium ion conductor is an Li-containing compound provided with a polyanion structural portion having at least either one of Ti and Zr, so excellent corrosion resistance is exhibited that electrochemical stability becomes higher. This results from Ti and Zr as an element which forms oxide covering on the surface thereof to easily be in a passive state, the so-called valve metal. Thus, it is conceived that an Li-containing compound provided with a polyanion structural portion having these elements exhibits so high corrosion resistance that electrochemical stability becomes higher.

The second lithium ion conductor in the present invention is not particularly limited if the second lithium ion conductor is such as to have a polyanion structural portion comprising an element of at least one kind among the above-mentioned elements and plural oxygen elements, but examples thereof can include Li₃BO₃, LiBO₂, Li₄SiO₄, Li₂Si₂O₃, Li₃PO₄, LiPO₃, Li₂Ti₂O₅, Li₂O₃, Li₄Ti₅O₁₂, Li₂ZrO₃, LiAlO₂, or a mixture thereof. Above all, the second lithium ion conductor is more preferably an Li-containing compound provided with a polyanion structural portion having either one of Ti and Zr, and particularly preferably Li₂Ti₂O₅.

(b) Other Components

The stabilization layer in the present invention may contain, in addition to the above-mentioned second lithium ion conductor, a conductive material and a binder which do not have reactivity with the above-mentioned cathode active material and solid electrolyte material. Examples of the conductive material can include acetylene black, Ketjen Black and carbon fiber. Examples of the binder can include fluorine-containing binders such as PTFE and PVDF.

(iii) Reaction Inhibition Portion

The ratio between the thickness of the lithium ion conductive layer containing the first lithium ion conductor and the thickness of the stabilization layer containing the second lithium ion conductor, which compose the reaction inhibition portion in the present invention, is properly determined in accordance with the all solid state battery; for example, in the case of regarding the thickness of the stabilization layer as 1, the ratio of the thickness of the lithium ion conductive layer to the thickness of the stabilization layer is preferably within a range of 0.01 to 100, and more preferably within a range of 1 to 100. The reason therefor is that the case where the thickness of the lithium ion layer is too thick with respect to the thickness of the stabilization layer brings a possibility that the first lithium ion conductor contacts the sulfide solid electrolyte material so easily as to increase interface resistance with time. On the other hand, the reason therefor is that the case where the thickness of the lithium ion layer is too thin with respect to the thickness of the stabilization layer brings a possibility of decreasing lithium ion conductivity. Incidentally, examples of a method for determining the ratio of the thickness of each layer, which composes the reaction inhibition portion in the present invention, can include an image analysis by using transmission electron microscope (TEM).

The form of the reaction inhibition portion in the present invention is not particularly limited if the reaction inhibition portion is such as to be formed on the surface of the above-mentioned cathode active material. For example, as shown in FIGS. 1A and 1B, in the case where the shape of the above-mentioned cathode active material is particulate, the reaction inhibition portion becomes in a form such as to cover the surface of the cathode active material particles. Also, a part in which the lithium ion conductive layer and the stabilization layer are laminated in the above-mentioned reaction inhibition portion preferably covers more areas of the particle surface of the cathode active material, and the specific coverage factor of the above-mentioned laminated part on the above-mentioned whole particle surface is preferably 80% or more, and more preferably 95% or more. Also, the whole particle surface of the cathode active material may be covered. Incidentally, examples of a measuring method for the coverage factor of the reaction inhibition portion can include transmission electron microscope (TEM) and X-ray photoelectron spectroscopy (XPS).

The thickness of the reaction inhibition portion in the present invention is not particularly limited if the thickness is such that the cathode active material and the sulfide solid electrolyte material do not react, but is, for example, preferably within a range of 1 nm to 500 nm, and more preferably within a range of 2 nm to 100 nm; the reason therefor is that the case where the thickness of the above-mentioned reaction inhibition portion is less than the above-mentioned range brings a possibility that the cathode active material and the sulfide solid electrolyte material react. On the other hand, the reason therefor is that the case where the thickness of the above-mentioned reaction inhibition portion exceeds the above-mentioned range brings a possibility of decreasing ion conductivity.

A forming method for the reaction inhibition portion in the present invention is not particularly limited if the method is such as to allow the reaction inhibition portion as described above to be formed. In the present invention, the method described in the item of the after-mentioned “B. Method for producing all solid state battery” may be appropriately used.

(3) Sulfide Solid Electrolyte Material

The cathode active material layer in the present invention preferably contains the sulfide solid electrolyte material. The reason therefor is to allow ion conductivity of the cathode active material layer to be improved. The sulfide solid electrolyte material is so high in reactivity as to react easily with the above-mentioned cathode active material and form a high resistive layer easily at an interface with the cathode active material. On the contrary, in the present invention, the formation of the above-mentioned reaction inhibition portion on the surface of the cathode active material allows interface resistance between the cathode active material and the sulfide solid electrolyte material to be effectively inhibited from increasing with time.

Examples of the sulfide solid electrolyte material can include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which “m” and “n” are positive numbers; Z is any of Ge, Zn and Ga), Li₂S—GeS₂, Li₂S—SiS₂—Li₃PO₄, and Li₂S—SiS₂—LiₓMO_{y} (in which “x” and “y” are positive numbers; M is any of P, Si, Ge, B, Al, Ga and In). Incidentally, the description of the above-mentioned “Li₂S—P₂S₅” signifies the sulfide solid electrolyte material obtained by using a raw material composition containing Li₂S and P₂S₅, and other descriptions signify similarly.

Also, in the case where the sulfide solid electrolyte material is obtained by using a raw material composition containing Li₂S and P₂S₅, the proportion of Li₂S to the total of Li₂S and P₂S₅ is, for example, preferably within a range of 70 mol % to 80 mol %, more preferably within a range of 72 mol % to 78 mol %, and further preferably within a range of 74 mol % to 76 mol %. The reason therefor is to allow the sulfide solid electrolyte material having an ortho-composition or a composition in the neighborhood of it and allow the sulfide solid electrolyte material with high chemical stability. Here, ortho generally signifies oxo acid which is the highest in degree of hydration among oxo acids obtained by hydrating the same oxide. In the present invention, a crystal composition to which Li₂S is added most among sulfides is called an ortho-composition. Li₃PS₄ corresponds to the ortho-composition in the Li₂S—P₂S₅ system. In the case of an Li₂S—P₂S₅-based sulfide solid electrolyte material, the proportion of Li₂S and P₂S₅ such as to obtain the ortho-composition is Li₂S:P₂S₅=75:25 on a molar basis. Incidentally, also in the case of using Al₂S₃ or B₂S₃ instead of P₂S₅ in the above-mentioned raw material composition, the preferable range is the same. Li₃AlS₃ corresponds to the ortho-composition in the Li₂S—Al₂S₃ system and Li₃BS₃ corresponds to the ortho-composition in the Li₂S—B₂S₃ system.

Also, in the case where the sulfide solid electrolyte material is obtained by using a raw material composition containing Li₂S and SiS₂, the proportion of Li₂S to the total of Li₂S and SiS₂ is, for example, preferably within a range of 60 mol % to 72 mol %, more preferably within a range of 62 mol % to 70 mol %, and further preferably within a range of 64 mol % to 68 mol %. The reason therefor is to allow the sulfide solid electrolyte material having an ortho-composition or a composition in the neighborhood of it and allow the sulfide solid electrolyte material with high chemical stability. Li₄SiS₄ corresponds to the ortho-composition in the Li₂S—SiS₂ system. In the case of an Li₂S—SiS₂-based sulfide solid electrolyte material, the proportion of Li₂S and SiS₂ such as to obtain the ortho-composition is Li₂S:SiS₂=66.7:33.3 on a molar basis. Incidentally, also in the case of using GeS₂ instead of SiS₂ in the above-mentioned raw material composition, the preferable range is the same. Li₄GeS₄ corresponds to the ortho-composition in the Li₂S—GeS₂ system.

Also, in the case where the sulfide solid electrolyte material is obtained by using a raw material composition containing LiX (X=Cl, Br and I), the proportion of LiX is, for example, preferably within a range of 1 mol % to 60 mol %, more preferably within a range of 5 mol % to 50 mol %, and further preferably within a range of 10 mol % to 40 mol %. Also, in the case where the sulfide solid electrolyte material is obtained by using a raw material composition containing Li₂O, the proportion of Li₂O is, for example, preferably within a range of 1 mol % to 25 mol %, and more preferably within a range of 3 mol % to 15 mol %.

Also, the sulfide solid electrolyte material may be sulfide glass, crystallized sulfide glass, or a crystalline material obtained by a solid phase method. Incidentally, the sulfide glass may be obtained by performing mechanical milling (such as ball mill) for a raw material composition, for example. Also, the crystallized sulfide glass may be obtained by heat-treating the sulfide glass at a temperature of crystallization temperature or higher, for example. Also, the lithium ion conductivity at normal temperature of the sulfide solid electrolyte material is, for example, preferably 1×10⁻⁵ S/cm or more, and more preferably 1×10⁻⁴ S/cm or more.

Examples of the shape of the sulfide solid electrolyte material in the present invention can include a particulate shape such as a perfectly spherical shape and an elliptically spherical shape, and a thin-film shape. In the case where the sulfide solid electrolyte material is in the above-mentioned particulate shape, the average particle diameter (D₅₀) thereof is not particularly limited but preferably 40 μm or less, more preferably 20 μm or less, and further preferably 10 μm or less. The reason therefor is to easily intend to improve filling factor in the cathode active material layer. On the other hand, the above-mentioned average particle diameter is preferably 0.01 μm or more, and more preferably 0.1 μm or more. Incidentally, the above-mentioned average particle diameter may be determined by a granulometer, for example.

(4) Cathode Active Material

The cathode active material layer in the present invention may further contain at least one of a conductive material and a binder in addition to the above-mentioned cathode active material, reaction inhibition portion and sulfide solid electrolyte material. Examples of the conductive material can include acetylene black, Ketjen Black and carbon fiber. Examples of the binder can include fluorine-containing binders such as PTFE and PVDF. The thickness of the above-mentioned cathode active material layer varies with constitutions of an intended all solid state battery, and is preferably within a range of 0.1 μm to 1000 μm, for example.

2. Solid Electrolyte Layer

Next, the solid electrolyte layer in the present invention is described. The solid electrolyte layer in the present invention is a layer containing at least a solid electrolyte material, and a layer formed between the cathode active material layer and the anode active material layer. As described above, in the case where the cathode active material layer contains the sulfide solid electrolyte material, the solid electrolyte material contained in the solid electrolyte layer is not particularly limited if the material is such as to have lithium ion conductivity, but may be the sulfide solid electrolyte material or other solid electrolyte material than the sulfide solid electrolyte material. On the other hand, in the case where the cathode active material layer does not contain the sulfide solid electrolyte material, the solid electrolyte layer contains the sulfide solid electrolyte material. In particular, in the present invention, both the cathode active material layer and the solid electrolyte layer preferably contain the sulfide solid electrolyte material. The reason therefor is to allow the effect of the present invention to be sufficiently produced. Also, the solid electrolyte material used for the solid electrolyte layer is preferably composed of only the sulfide solid electrolyte material.

Incidentally, the sulfide solid electrolyte material is the same as the contents described in the item of the above-mentioned “1. Cathode active material layer”. Also, the same material as a solid electrolyte material used for a general all solid state battery may be used for other solid electrolyte material than the sulfide solid electrolyte material.

The thickness of the solid electrolyte layer in the present invention is preferably, for example, within a range of 0.1 μm to 1000 μm, above all, within a range of 0.1 μm to 300 μm.

3. Anode Active Material Layer

Next, the anode active material layer of the present invention is described. The anode active material layer in the present invention is a layer containing at least the anode active material, and may contain at least one of a solid electrolyte material and a conductive material as required. The anode active material is not particularly limited if the charge and discharge electric potential thereof is a base electric potential as compared with the charge and discharge electric potential of the cathode active material contained in the above-mentioned cathode active material layer, but examples thereof can include a metal active material and a carbon active material. Examples of the metal active material can include Li alloy, In, Al, Si, and Sn. On the other hand, examples of the carbon active material can include mesocarbon microbeads (MCMB), high orientation property graphite (HOPG), hard carbon and soft carbon. Incidentally, the solid electrolyte material and the conductive material used for the anode active material layer are the same as the above-mentioned case in the cathode active material layer. Also, the thickness of the anode active material layer is within a range of 0.1 μm to 1000 μm, for example.

4. Other Constitutions

The all solid state battery of the present invention has at least the above-mentioned cathode active material layer, solid electrolyte layer and anode active material layer, and ordinarily further has a cathode current collector for current-collecting the cathode active material layer and an anode current collector for current-collecting the anode active material layer. Examples of a material for the cathode current collector can include SUS, aluminum, nickel, iron, titanium and carbon, and preferably SUS among them. On the other hand, examples of a material for the anode current collector can include SUS, copper, nickel and carbon, and preferably SUS among them. Also, the thickness, shape, and other elements of the cathode current collector and the anode current collector are preferably selected properly in accordance with factors such as uses of all the solid state battery. Also, a battery case used for a general all solid state battery may be used for a battery case used for the present invention, and examples thereof can include a battery case made of SUS. Also, the all solid state battery of the present invention may be such that a power generating element is formed inside an insulating ring.

5. All Solid State Battery

The all solid state battery of the present invention may be a primary battery or a secondary battery, and preferably be a secondary battery among them. The reason therefor is to be repeatedly charged and discharged and be useful as a car-mounted battery, for example. Examples of the shape of all the solid state battery of the present invention include a coin shape, a laminate shape, a cylindrical shape and a rectangular shape. A method for producing the all solid state battery of the present invention is not particularly limited if the method is such as to allow the above-mentioned all solid state battery to be obtained, but the after-mentioned method for producing the all solid state battery may be appropriately used.

B. Method for Producing all Solid State Battery

Next, a method for producing the all solid state battery of the present invention is described. The method for producing the all solid state battery of the present invention is a method for producing the above-mentioned all solid state battery, comprising steps of: a lithium ion conductive layer forming step of forming a lithium ion conductive layer by applying and heat-treating a first precursor coating liquid containing a raw material for the above-mentioned first lithium ion conductor on a surface of a cathode active material, and a stabilization layer forming step of forming a stabilization layer by applying and heat-treating a second precursor coating liquid containing a raw material for the above-mentioned second lithium ion conductor on a surface of the lithium ion conductive layer covered with the cathode active material. The wording “heat-treating” in this case is not particularly limited if the heat-treating is a treatment such as to solidify each layer by applying heat thereto, but ordinarily signifies drying and burning.

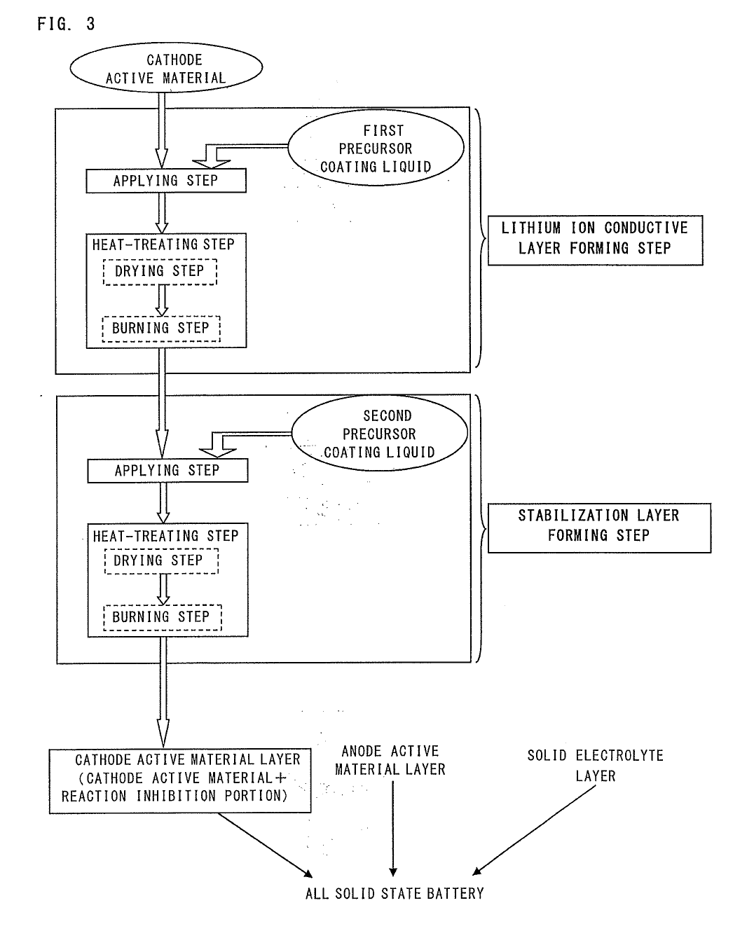

FIG. 3 is a flow chart explaining an example of the method for producing the all solid state battery of the present invention. In FIG. 3, the producing method of the cathode active material layer is a method for performing a lithium ion conductive layer forming step and a stabilization layer forming step for the cathode active material. First, the lithium ion conductive layer forming step is performed. A first precursor coating liquid containing a raw material for a first lithium ion conductor is applied on a surface of a cathode active material (applying step) to dry the applied surface (drying step), which is finally burned (burning step). A lithium ion conductive layer is formed by performing the applying step and a heat-treating step of the drying step and the burning step as mentioned above. Next, the stabilization layer forming step is performed. A second precursor coating liquid containing a raw material for a second lithium ion conductor is applied on the cathode active material which underwent the lithium ion conductive layer forming step as mentioned above (applying step) to dry the applied surface (drying step), which is finally burned (burning step). A stabilization layer is formed by performing the applying step and a heat-treating step of the drying step and the burning step as mentioned above. The cathode active material, on whose surface a reaction inhibition portion having two layers of the lithium ion conductive layer and the stabilization layer is formed, may be obtained through two forming steps as mentioned above. Also, an all solid state battery comprising a cathode active material layer using the above-mentioned cathode active material, an anode active material layer and a solid electrolyte layer is obtained.

According to the present invention, the heat-treating step is performed after applying in each of the applying step in applying the above-mentioned two kinds of coating liquids, whereby the lithium ion conductive layer and the stabilization layer are formed as separate layers to allow the reaction inhibition portion having a two-layer structure to be formed. Here, the surface of the lithium ion conductive layer is covered with the stabilization layer, so that the first lithium ion conductor is inhibited from deteriorating due to the contact with the sulfide solid electrolyte material; thus, interface resistance between the cathode active material and the sulfide solid electrolyte material may be inhibited from increasing with time, and the all solid state battery excellent in Li ion conductivity and durability may be produced simply and easily.

The method for producing the all solid state battery of the present invention is hereinafter described in each step.

1. Lithium Ion Conductive Layer Forming Step

First, the lithium ion conductive layer forming step in the present invention is described. The lithium ion conductive layer forming step in the present invention has applying step of an applying the first precursor coating liquid containing a raw material for the first lithium ion conductor on the surface of the above-mentioned cathode active material so as to be the after-mentioned thickness, and a heat-treating step of solidifying the above-mentioned cathode active material applied with the coating liquid by applying heat; in which the heat-treating step as mentioned above ordinarily has a drying step of drying the above-mentioned cathode active material applied with the coating liquid and a burning step of burning thereafter.

(1) Applying Step

The applying step in lithium ion conductive layer forming step is a step of applying the after-mentioned first precursor coating liquid on the surface of the cathode active material.

(i) First Precursor Coating Liquid

The first precursor coating liquid in present step contains the first lithium ion conductor. The raw material for the first lithium ion conductor contained in the first precursor coating liquid in present step is not particularly limited if the material is such as to allow the intended first lithium ion conductor to be formed. Examples of the first lithium ion conductor can include the same as is described in the item of the above-mentioned “A. All solid state battery”; above all, in the present invention, the first lithium ion conductor is preferably LiNbO₃. An Li-feeding compound and an Nb-feeding compound may be used as a raw material for LiNbO₃. Examples of the Li-feeding compound can include Li alkoxide such as lithium ethoxide and lithium methoxide, and a lithium salt such as lithium hydroxide and lithium acetate. Also, examples of the Nb-feeding compound can include Nb alkoxide such as pentaethoxyniobium and pentamethoxyniobium, and a niobium salt such as niobium hydroxide and niobium acetate. Incidentally, the concentration of the raw material for the first lithium ion conductor contained in the first precursor coating liquid is properly determined in accordance with factors such as the composition of the intended reaction inhibition portion.

The above-mentioned first precursor coating liquid may be ordinarily obtained by dissolving or dispersing the raw material for the first lithium ion conductor in a solvent. The solvent used for the first precursor coating liquid is not particularly limited if the solvent is such as to allow the raw material for the first lithium ion conductor to be dissolved or dispersed and such as not to deteriorate the raw material for the above-mentioned first lithium ion conductor. Examples thereof can include methanol, ethanol and propanol. Also, the above-mentioned solvent is preferably small in moisture amount from the viewpoint of inhibiting the above-mentioned raw material from being deteriorated. A sol-gel solution such as to be made into a sol state by hydrolysis and polycondensation reaction of a compound as a raw material for the ion conductor contained therein, and made into a gel state by progress of polycondensation reaction and aggregation is used in the present invention.

Incidentally, the first precursor coating liquid used for the present step may contain an optional addition agent such as a conductive material and a binder as required, and examples of the conductive material can include acetylene black, Ketjen Black and carbon fiber. Examples of the binder can include fluorine-containing binders such as PTFE and PVDF.

(ii) Cathode Active Material

The cathode active material in the present step reacts with the sulfide solid electrolyte material to form a high resistive layer, and is the same as the contents described in the item of the above-mentioned “A. All solid state battery”; therefore, the description herein is omitted.

(iii) Applying Step

In the present step, the method for applying the above-mentioned first precursor coating liquid is preferably an applying method such as to allow the coating liquid to be uniformly applied; examples thereof can include a spin coat method, a dip coat method, a spray coat method and an impregnation method. Above all, the applying by using a spin coat method is preferable. The reason therefor is to allow a thin film to be efficiently produced. Also, the applying atmosphere is not particularly limited if the applying atmosphere is such as to allow the intended lithium ion conductive layer to be formed and such as not to be an atmosphere in which the lithium ion conductive layer and the cathode active material are deteriorated.

In the present step, the thickness of the applying layer of the above-mentioned first precursor coating liquid is properly determined in accordance with the thickness of the intended reaction inhibition portion and other factors, and preferably satisfies the range of the thickness of the lithium ion conductive layer, which is described in the item of the above-mentioned “A. All solid state battery”.

(2) Heat-Treating Step

The seat-treating step in the lithium ion conductive layer forming step is a step of solidifying the above-mentioned cathode active material applied with the first precursor coating liquid by applying heat thereto, and ordinarily has a drying step of drying the above-mentioned cathode active material applied with the coating liquid and a burning step of burning thereafter.

(i) Drying Step

The drying step in the present step removes a solvent contained in the above-mentioned applied first precursor coating liquid to dry the cathode active material.

The drying method in the present step is not particularly limited if the drying method is such an approach that the solvent of the above-mentioned first precursor coating liquid may be removed to dry the cathode active material layer, but the approach may be properly selected. Examples thereof can include a hot-air drying method, a vacuum drying method, an evaporation drying method, a freeze drying method, a spray drying method and a drying method under reduced pressure.

The drying temperature in the present step may be properly selected in accordance with volatility of the solvent used for the first precursor coating liquid, and is not particularly limited if the drying temperature is such that the solvent contained in the above-mentioned coating liquid may be removed to dry the cathode active material. Also, the drying time in the present step may be properly selected in accordance with volatility of the solvent used for the above-mentioned coating liquid, and is not particularly limited if the drying time is such that the solvent contained in the above-mentioned applied first precursor coating liquid may be removed to dry the cathode active material.

(ii) Burning Step

The burning step in the present step applies heat to the above-mentioned cathode active material applied with the first precursor coating liquid to solidify the lithium ion conductive layer formed on the surface of the cathode active material.

The burning method in the present step is not particularly limited if the burning method is such an approach that does not deteriorate the above-mentioned lithium ion conductive layer and cathode active material, but examples thereof can include a reaction burning method, an atmosphere burning method and a thermal plasma method.

The burning atmosphere in the present step is not particularly limited if the burning atmosphere is such as to allow the above-mentioned lithium ion conductive layer to be solidified and such as not to be an atmosphere in which the above-mentioned lithium ion conductive layer and cathode active material are deteriorated, but examples thereof can include air atmosphere; inert gas atmosphere such as nitrogen atmosphere and argon atmosphere; reducing atmosphere such as ammonia atmosphere, hydrogen atmosphere and carbon monoxide atmosphere; and vacuum.

The burning temperature in the present step is not particularly limited if the burning temperature is such as to allow the above-mentioned lithium ion conductive layer to be solidified and such as to be a temperature at which the above-mentioned lithium ion conductive layer and cathode active material are not deteriorated, but is, for example, preferably within a range of 150° C. to 600° C., more preferably within a range of 200° C. to 500° C., and particularly preferably within a range of 300° C. to 400° C. The reason therefor is that the case where the above-mentioned burning temperature is less than the above-mentioned range brings a possibility that the lithium ion conductive layer be not sufficiently formed. On the other hand, the reason therefor is that the case where the above-mentioned burning temperature exceeds the above-mentioned range brings a possibility of deteriorating the lithium ion conductive layer and the cathode active material.

The burning time in the present step is not particularly limited if the burning time is such as to allow the above-mentioned lithium ion conductive layer to be obtained in a solidified state, but is, for example, preferably within a range of 0.5 hour to 10 hours, and more preferably within a range of 3 hours to 7 hours. The reason therefor is that the case where the above-mentioned burning time is less than the above-mentioned range brings a possibility that the lithium ion conductive layer be not sufficiently formed. On the other hand, the reason therefor is that the case where the above-mentioned burning time exceeds the above-mentioned range brings a possibility that the lithium ion conductive layer and the cathode active material be excessively heat-treated and thereby deteriorated.

2. Stabilization Layer Forming Step

Next, the stabilization layer forming step in the present invention is described. The stabilization layer forming step in the present invention has an applying step of applying the second precursor coating liquid containing a raw material for the second lithium ion conductor on the surface of the lithium ion conductive layer covered with the above-mentioned cathode active material so as to be the after-mentioned thickness, and a heat-treating step of solidifying the above-mentioned cathode active material applied with the coating liquid by applying heat; in which the heat-treating step as mentioned above ordinarily has a drying step of drying the above-mentioned cathode active material applied with the coating liquid and a burning step of burning thereafter.

(1) Applying Step

The applying step in the stabilization layer forming step is a step of applying the after-mentioned second precursor coating liquid on the surface of the lithium ion conductive layer covered with the cathode active material.

(i) Second Precursor Coating Liquid

The second precursor coating liquid in the present step contains a raw material for the second lithium ion conductor. The raw material for the second lithium ion conductor contained in the second precursor coating liquid used in the present step is not particularly limited if the material is such as to allow the second lithium ion conductor to be formed.

The raw material for the second lithium ion conductor is not particularly limited if the material is such as to allow an intended Li-containing compound to be formed, but examples thereof can include hydroxide, a oxide, a metal salt, metal alkoxide and a metal complex. Incidentally, in the present invention, a previously synthesized compound may be used as the raw material for the second lithium ion conductor. Here, as described in the item of the above-mentioned “A. All solid state battery”, the second lithium ion conductor is an Li-containing compound provided with a polyanion structural portion having at least one of B, Si, P, Ti, Zr, Al and W. Also, the polyanion structural portion comprises an element of at least one kind among the above-mentioned elements and plural oxygen elements. Thus, the second lithium ion conductor may be represented by a general formula LiₓAO_{y} (A is at least one kind of B, Si, P, Ti, Zr, Al and W, and “x” and “y” are positive numbers), for example. In the present invention, the second lithium ion conductor is preferably Li₂Ti₂O₅.

Also, with regard to the raw material for the second lithium ion conductor, in the general formula LiₓAO_{y} of the above-mentioned Li-containing compound, in the case where A is a metallic element, for example, Li alkoxide such as ethoxylithium and methoxylithium, and a lithium salt such as lithium hydroxide and lithium acetate are used as the Li-feeding compound; and a metal oxide, a metal salt and a metal complex containing the above-mentioned A are used as an A-feeding compound. For example, in the case where the above-mentioned Li-containing compound is Li₂Ti₂O₅, ethoxylithium of the Li-feeding compound and tetraisopropoxytitanium of a Ti-feeding compound may be used as the raw material. On the other hand, in the general formula of the above-mentioned Li-containing compound, in the case where the A element is a nonmetal, for example, an intended Li-containing compound may be directly used. For example, in the case where the above-mentioned Li-containing compound is Li₃PO₄, Li₃PO₄ may be used as the raw material for the second lithium ion conductor. Also, in the general formula of the above-mentioned Li-containing compound, in the case where A is B (boron), the above-mentioned Li-feeding compound and a boric acid as a B-feeding compound may be used as the raw material for the second lithium ion conductor. Incidentally, an O-feeding compound of the above-mentioned Li-containing compound may be the raw material for the second lithium ion conductor, or water contained in the second precursor coating liquid in the present invention. The content of the raw material for the second lithium ion conductor contained in the second precursor coating liquid in the present step is properly selected in accordance with the intended reaction inhibition portion.

In the present step, similarly to the above-mentioned first precursor coating liquid, the second precursor coating liquid may be obtained by dissolving or dispersing the raw material for the second lithium ion conductor in a solvent. The solvent used for the second precursor coating liquid is not particularly limited if the solvent is such as to allow the raw material for the second lithium ion conductor to be dissolved or dispersed and such as not to deteriorate the above-mentioned compound, but examples thereof can include methanol, ethanol and propanol. Also, the above-mentioned solvent is preferably small in moisture amount from the viewpoint of inhibiting the above-mentioned raw material from being deteriorated. A sol-gel solution such as to be made into a sol state by hydrolysis and polycondensation reaction of a compound as a raw material for the ion conductor contained therein, and made into a gel state by progress of polycondensation reaction and aggregation is used in the present invention.

Incidentally, the second precursor coating liquid used for the present step may contain an optional addition agent such as a conductive material and a binder as required, and examples of the conductive material can include acetylene black, Ketjen Black and carbon fiber. Examples of the binder can include fluorine-containing binders such as PTFE and PVDF.

(ii) Cathode Active Material and Covered Lithium Ion Conductive Layer

The cathode active material and the covered lithium ion conductive layer in the present step are the same as the contents described in the item of the above-mentioned “1. Lithium ion conductive layer forming step”; therefore, the description herein is omitted.

(iii) Applying Step

In the present step, the method for applying the above-mentioned second precursor coating liquid is the same as the applying method described in the above-mentioned “1. Lithium ion conductive layer forming step”; therefore, the description herein is omitted. Also, the thickness of the stabilization layer formed by the present step is properly determined in accordance with the thickness of the intended reaction inhibition portion and other factors, and preferably satisfies the range of the thickness of the stabilization layer, which is described in the item of the above-mentioned “A. All solid state battery”.

(2) Heat-Treating Step

The seat-treating step in the stabilization layer forming step is a step of solidifying the above-mentioned cathode active material applied with the second precursor coating liquid by applying heat thereto, and ordinarily has a drying step of drying the above-mentioned cathode active material applied with the coating liquid and a burning step of burning thereafter. The drying step and burning step in the stabilization layer forming step are the same as the contents described in the above-mentioned “1. Lithium ion conductive layer forming step”; therefore, the description herein is omitted.

3. Other Steps

The present invention is not particularly limited if the present invention is such as to have above-mentioned steps, but, in the case where the cathode active material used for the present invention is in a particulate shape, examples thereof can include: a cathode active material layer forming step of forming the cathode active material layer by pressing a material composing the cathode active material layer, such as the cathode active material on whose surface the reaction inhibition portion is formed by above-mentioned step, with a pressing machine; a solid electrolyte layer forming step of forming the solid electrolyte layer by pressing a material composing the solid electrolyte layer similarly; and an anode active material layer forming step of forming the anode active material layer by pressing a material composing the anode active material layer similarly. Also, in the case where the cathode active material is in a thin-film shape, examples thereof can include a solid electrolyte layer forming step of laminating a material composing the solid electrolyte layer on the cathode active material on whose surface the reaction inhibition portion is formed by the above-mentioned step, and an anode active material layer forming step of laminating a material composing the anode active material layer on the solid electrolyte layer. Incidentally, the anode active material layer and the solid electrolyte layer in the present invention are the same as the contents described in the item of the above-mentioned “A. All solid state battery”; therefore, the description herein is omitted.

Also, the present invention may have as other steps: a step of disposing the cathode current collector on the surface of the cathode active material layer, a step of disposing the anode current collector on the surface of the anode active material layer, and a step of storing the power generating element in the battery case. Incidentally, the cathode current collector, the anode current collector and the battery case are the same as the contents described in the item of the above-mentioned “A. All solid state battery”; therefore, the description herein is omitted.

The present invention is not limited to the above-mentioned embodiments. The above-mentioned embodiments are exemplification, and those having substantially the same constitution as the technical idea described in the claims of the present invention and producing similar operation and effect thereto are included in the technical scope of the present invention.

### EXAMPLES

The present invention is described more specifically while showing Examples hereinafter.

### Example

### Preparation of First Precursor Coating Liquid

1 mmol of lithium ethoxide (manufactured by Kojundo Chemical Lab. Co., Ltd.) and 1 mmol of pentaethoxyniobium (manufactured by Kojundo Chemical Lab. Co., Ltd.) were mixed in 20 ml of ethanol (manufactured by Wako Pure Chemical Industries, Ltd.) to obtain a first precursor coating liquid (an LiNbO₃ precursor sol-gel solution).

(Preparation of Second Precursor Coating Liquid)

1 mmol of lithium ethoxide (manufactured by Kojundo Chemical Lab. Co., Ltd.) and 1 mmol of titanium tetraisopropoxide (manufactured by Kojundo Chemical Lab. Co., Ltd.) were mixed in 20 ml of ethanol (manufactured by Wako Pure Chemical Industries, Ltd.) to obtain a second precursor coating liquid (an Li₂Ti₂O₅ precursor sol-gel solution).

(Formation of Lithium Ion Conductive Layer)

A lithium cobaltate thin film (a cathode active material) was obtained on an Au substrate by sputtering. The first precursor coating liquid was applied at 5000 rpm for 10 seconds on the lithium cobaltate thin film surface by using a spin coater (MS-A100™, manufactured by Mikasa, Co., Ltd.), dried and thereafter burned at 350° C. for 0.5 hour to obtain a lithium ion conductive layer with a thickness of 5 nm.

(Formation of Stabilization Layer)

The second precursor coating liquid was applied at 5000 rpm for 10 seconds on the surface of the above-mentioned lithium ion conductive layer by using a spin coater (MS-A100™, manufactured by Mikasa, Co., Ltd.), dried and thereafter burned at 350° C. for 0.5 hour to obtain a stabilization layer with a thickness of 5 nm.

(Formation of Reaction Inhibition Portion)

A reaction inhibition portion having two layers of the lithium ion conductive layer on the active material side and the stabilization layer on the solid electrolyte side was formed on the surface of the cathode active material by forming steps of the above-mentioned lithium ion conductive layer and the above-mentioned stabilization layer to obtain an electrode having the cathode active material on whose surface the reaction inhibition portion was formed.

(Production of all Solid State Battery)

50 mg of 75Li₂S-25P₂S₅ was charged into a cylinder in a small-sized cell and pressed (1.0 t/cm², 1 min) by upper and lower pistons while leveled evenly with a spatula to form a solid electrolyte. Next, the above-mentioned electrode was pressed similarly (4 t/cm², 1 min) on the solid electrolyte layer to form a cathode active material layer. Subsequently, an Li—In foil was pressed similarly (1.0 t/cm², 1 min) on the opposite face to the face on which the cathode active material layer of the solid electrolyte layer was formed to form an anode active material layer and then obtain a power generating element. Next, after fastening the bolt of the small-sized cell, the wiring was connected to produce an all solid state battery by assembling after putting a drying agent in a glass cell.

### Comparative Example 1

1 mmol of lithium ethoxide (manufactured by Kojundo Chemical Lab. Co., Ltd.) and 1 mmol of pentaethoxyniobium (manufactured by Kojundo Chemical Lab. Co., Ltd.) were mixed in 10 ml of ethanol (manufactured by Wako Pure Chemical Industries, Ltd.) to obtain a first precursor coating liquid (an LiNbO₃ precursor sol-gel solution). Next, only the first precursor coating liquid was applied at 5000 rpm for 10 seconds on the lithium cobaltate thin film surface by using a spin coater (MS-A100™, manufactured by Mikasa, Co., Ltd.), dried and thereafter burned at 350° C. for 0.5 hour to obtain a lithium ion conductive layer with a thickness of 5 nm. An all solid state battery in which this electrode was used for a cathode and an Li—Li foil was used for an anode active material layer was obtained.

### Comparative Example 2

1 mmol of lithium ethoxide (manufactured by Kojundo Chemical Lab. Co., Ltd.) and 1 mmol of titanium tetraisopropoxide (manufactured by Kojundo Chemical Lab. Co., Ltd.) were mixed in 10 ml of ethanol (manufactured by Wako Pure Chemical Industries, Ltd.) to obtain a second precursor coating liquid (an Li₂Ti₂O₅ precursor sol-gel solution). Next, the second precursor coating liquid was applied at 5000 rpm for 10 seconds on the lithium cobaltate thin film surface by using a spin coater (MS-A100™, manufactured by Mikasa, Co., Ltd.), dried and thereafter burned at 350° C. for 0.5 hour to obtain a stabilization layer with a thickness of 5 nm. An all solid state battery in which this electrode was used for a cathode and an Li—Li foil was used for an anode active material layer was obtained.

[Evaluation 1]

(Interface Resistance Measurement of all Solid State Battery)

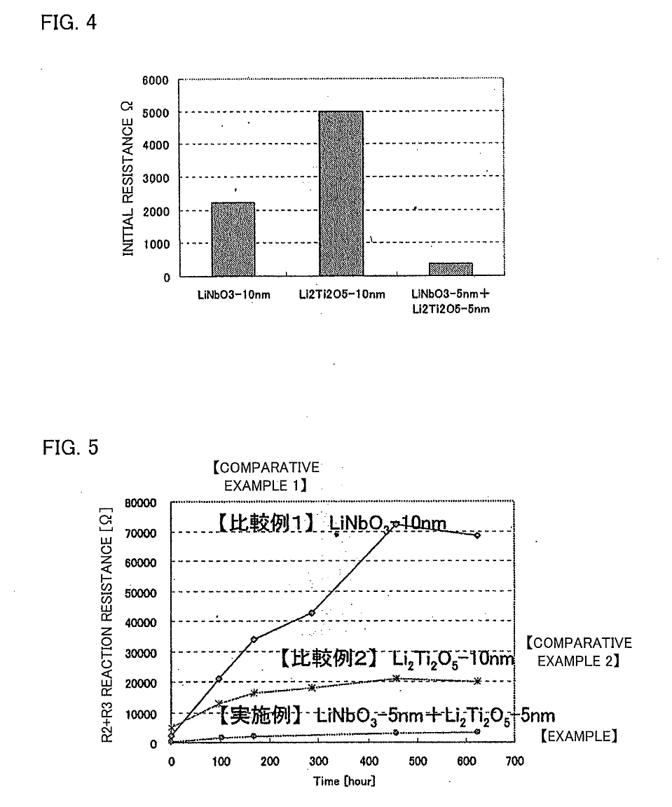

The initial interface resistance of the all solid state battery obtained in each of Example and Comparative Examples 1 and 2 was measured. First, after adjusting the electric potential of the all solid state battery to 3.93 V, the interface resistance of the all solid state battery was calculated by performing complex impedance measurement. Incidentally, the interface resistance was determined from the diameter of the circular arc of the impedance curve. The results are shown in FIG. 4. Thereafter, the all solid state battery was preserved at a temperature of 60° C. for one month to calculate the interface resistance of the all solid state battery after being preserved and then measure a change in the interface resistance with time. The results are shown in FIG. 5.

As shown in FIG. 4, with regard to Example, it was confirmed that the initial interface resistance value was low as compared with Comparative Examples 1 and 2. Also, as shown in FIG. 5, with regard to Example, it was confirmed that the interface resistance was inhibited from increasing with time as compared with Comparative Examples 1 and 2. In the case of Comparative Example 1 where the reaction inhibition portion was composed of only LiNbO₃, the initial interface resistance was inhibited, but it is assumed that an increase in the interface resistance became gradually remarkable for the reason that LiNbO₃ reacted with the sulfide solid electrolyte material to change the structure of the reaction inhibition portion. Also, in the case of Comparative Example 2, electrochemical stability of Ti inhibited the interface resistance from increasing with time, but it is assumed that the initial interface resistance value became high by reason of poor conductivity.

On the contrary, as Example, the case where the reaction inhibition portion is composed of two kinds of layers, which are the lithium ion conductive layer having LiNbO₃ as the first lithium ion conductor and the stabilization layer having Li₂Ti₂O₅ as the second lithium ion conductor, has two characteristics together, which are the inhibition of the initial interface resistance by the first lithium ion conductor and the inhibition of structural change of the cathode active material due to the contact with the sulfide solid electrolyte material by the second lithium ion conductor, so that it is assumed that the initial interface resistance and a change in the interface resistance with time may be inhibited.

### Comparative Example 3

An all solid state battery was obtained in the same manner as Example except for not burning in forming the lithium ion conductive layer.

[Evaluation 2]

(TEM Measurement)

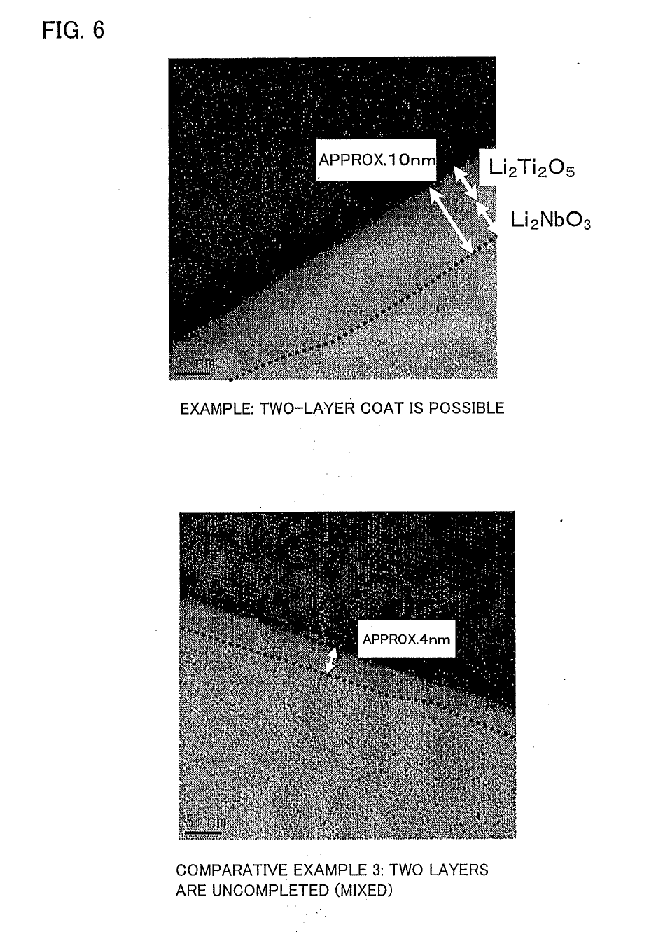

The cross section of the electrode of the all solid state battery obtained in Example and Comparative Example 3 was observed with a transmission electron microscope (TEM). The results are shown in FIG. 6. As shown in FIG. 6, in both Example and Comparative Example 3, the formation of the reaction inhibition portion was confirmed on the lithium cobaltate as the cathode active material. In Example, each of the lithium ion conductive layer having LiNbO₃ and the stabilization layer having Li₂Ti₂O₅ were covered as a separate layer; whereas in Comparative Example 3, the lithium ion conductive layer and the stabilization layer were burned at one time, so that it was confirmed that the lithium ion conductive layer and the stabilization layer were covered as a monolayer in which LiNbO₃ and Li₂Ti₂O were dispersed.

[Evaluation 3]

(Interface Resistance Measurement of all Solid State Battery)

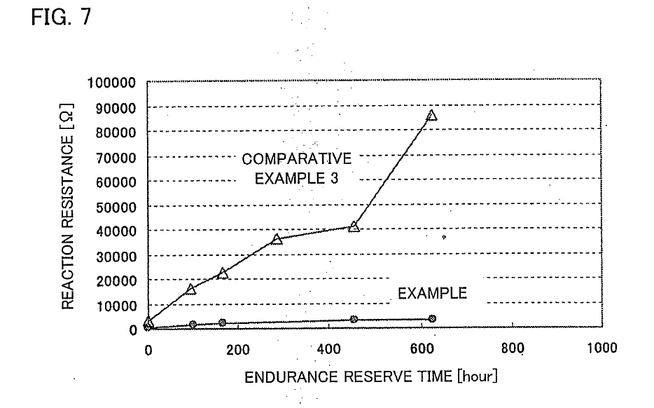

The interface resistance of the all solid state battery obtained in each of Example and Comparative Example 3 was measured. The measuring method is the same as the method described in the item of the above-mentioned “Evaluation 1”. The result is shown in FIG. 7. With regard to Example, it was confirmed that the interface resistance was inhibited from increasing with time as compared with Comparative Example 3. In Comparative Example 3, the layer in which LiNbO₃ and Li₂Ti₂O were dispersed contacts the sulfide solid electrolyte layer, so that it is conceived that the direct contact of LiNbO₃ with the sulfide solid electrolyte layer promotes the deterioration to cause an increase in the interface resistance with time. On the other hand, in Example, the structure is such that the surface of the lithium ion conductive layer is covered with the stabilization layer, and LiNbO₃ does not directly contact the sulfide solid electrolyte layer, so that it is conceived that the deterioration is inhibited from progressing unlike Comparative Example 3, and consequently the interface resistance is also inhibited from increasing with time.

### REFERENCE SIGNS LIST

1 . . . Cathode active material layer
2 . . . Anode active material layer
3 . . . Solid electrolyte layer
4 . . . Cathode active material
5 . . . Sulfide solid electrolyte material
6 . . . Reaction inhibition portion
7 . . . Lithium ion conductive layer
8 . . . Stabilization layer
10 . . . Power generating element

1. An all solid state battery comprising a cathode active material layer containing a cathode active material, an anode active material layer containing an anode active material, and a solid electrolyte layer formed between the cathode active material layer and the anode active material layer,
wherein at least one of the cathode active material layer and the solid electrolyte layer contains a sulfide solid electrolyte material,
a reaction control portion having two layers of a lithium ion conductive layer having a first lithium ion conductor on an active material side and a stabilization layer having a second lithium ion conductor on a solid electrolyte layer side is formed on a surface of the cathode active material,
the first lithium ion conductor is an Li-containing compound with a lithium ion conductivity of 1.0×10⁻⁷ S/cm or more at normal temperature, and
the second lithium ion conductor is an Li-containing compound provided with a polyanion structural portion having at least one of B, Si, P, Ti, Zr, Al and W.

2. The all solid state battery according to claim 1, wherein the first lithium ion conductor is LiNbO₃.

3. The all solid state battery according to claim 1, wherein the second lithium ion conductor is Li₂Ti₂O₅.

4. A method for producing the all solid state battery according to claim 1, comprising steps of:
a lithium ion conductive layer forming step of forming the lithium ion conductive layer by applying and heat-treating a first precursor coating liquid containing a raw material for the first lithium ion conductor on a surface of the cathode active material, and
a stabilization layer forming step of forming the stabilization layer by applying and heat-treating a second precursor coating liquid containing a raw material for the second lithium ion conductor on a surface of the lithium ion conductive layer covered with the cathode active material.

5. The method for producing the all solid state battery according to claim 4, wherein the first lithium ion conductor is LiNbO₃.

6. The method for producing the all solid state battery according to claim 4, wherein the second lithium ion conductor is Li₂Ti₂O₅.
